(19) United States
(12) Patent Application Publication
(10) Pub. No.: US 2002/0161668 A1
(43) Pub. Date: Oct. 31, 2002

(54) Interactive product configuration and ordering utilizing reasoning feedback information

(75) Inventors: Keith A. Lutz, Cleveland Heights, OH (US); Marybeth Courtwright, Painesville, OH (US); Karen Ross, Ajax (CA); Roger M. Mikulandra, Mentor, OH (US); Daniel D. Means, Mentor, OH (US); David M. Pillar, Concord, OH (US); Karen C. Brainard, Painesville, OH (US)

Correspondence Address: Attn: Marc E. Brown, OPPENHEIMER WOLFF & DONNELLY LLP, Suite 3800, 2029 Century Park East, Los Angeles, CA, 90067, US

(73) Assignee: Avery Dennison Corporation

(21) Appl. No.: 10/098,879

(22) Filed: Mar. 13, 2002

Related U.S. Application Data
(60) Provisional application No. 60/275,298, filed on Mar. 13, 2001.

(51) Int. Cl. G06F 17/60

(52) U.S. Cl. 705/26

(57) ABSTRACT

A method performable over the Internet is disclosed, wherein a prospective purchaser is presented with a series of product configuration choices. A computer performing the method receives a series of product configuration choices from the prospective user, consults a database to determine whether the selected choices result in a permissible combination, and displays advice to the prospective purchaser about whether the choices result in a permissible combination and, if not, about the nature of the impermissibility. The computer then receives a new series of product configuration choices from the prospective user, with the new choices having been affected by the prospective user's consideration of the advice about the nature of the impermissibility of the previous, impermissible combinations of product configuration choices.

### RELATED APPLICATIONS

This Application claims priority to U.S. Provisional Application No. 60/275,298 filed Mar. 13, 2001, the contents of which are incorporated herein by reference.

### BACKGROUND OF THE INVENTION

1. Field of the Invention

The present invention relates to computer based systems and methods for providing interactive information to users during specification selection and product ordering. More particularly, the present invention relates to providing users with interactive capabilities for determining permissibility of product component combinations requested by the users when selecting specifications and placing orders for paper products, such as labels, pressure sensitive papers and film, and the like.

2. General Background and State of the Art

Interactive systems for allowing users to determine product information, including vendor availability of products, pricing information, and the like, have long been known in the art. For example, customers have long been able to order merchandise from merchants or operators such as through a catalogue offering products for sale therein. Product information about the merchandise is then made available to the customer at the time of order processing. Product information used in prior art systems typically includes availability, timing, and pricing data related to the ordered products.

More recently, systems have been available for use with point-of-sale equipment, whereby a vendor or manufacturer inventory database may be queried at the point-of-sale to determine product information. However, such systems generally require customers to place an order prior to learning the product information. Therefore, customers' orders are placed without the benefit of the product information. In systems that allow customers to customize a product by selecting various product components, customers thereby have a hindered ability to make decisions that will reliably lead to selecting permissible combinations of the product components.

These problems are manifested, among other places, within the paper products and labels market. For example, in a first type of prior art product configuration system, a customer may decide to order a certain type of label, comprising specific components. A customer may attempt to order labels having a certain type of facestock, a certain type of adhesive, and a certain type of liner. Generally, customers select these components according to their needs, without the benefit of knowing which of the components may be permissibly combined. Inevitably, some customers must be informed, after placing their order, that the customer-configured product is unavailable or not able to be constructed because the customer has selected impermissible product component combinations.

In other types of prior art systems, a customer may be prevented from making impermissible choices altogether. In these systems, subsequent options presented to customers depend upon previous selections by the customer such that impermissible subsequent options are simply not made available to the customer. Although the customer is prevented, in this way, from making impermissible product component selections, the customer is denied information about the totality of options that could be available to him.

In addition to the inconvenience of making decisions predicated upon a lack of important information, such methods are inherently inefficient. Time is wasted when a decision making process must be repeated to incorporate negative feedback acquired when the customer attempts to place an order. That is, customers are forced to expend valuable time when they must re-formulate specifications and place a new order because their previous order included impermissible product component combinations. This inefficient process wastes time and may frustrate potential customers.

### SUMMARY OF THE INVENTION

The present invention provides customers with an interactive query capability useful in making decisions, leading to designation of product specifications and order placement. The invention provides customers with permissibility information that is indicative as to whether selected product components can be combined. Combinations of product components that are unable to be combined are impermissible; and combinations of product components that are able to be combined are permissible. A number of factors can affect permissibility, and any of these factors may therefore be included in the generation of “permissibility information” as utilized by the present invention. Such factors include, but are not limited to, physical compatibility of product components, availability of product components, prior ordering history of products or product components, and price of products or product components.

In addition to permissibility information, the present invention provides users with reasoning information regarding the permissibility or impermissibility of product component combinations. The reasoning information, informs customers about why a certain product is unavailable or why certain component combinations are impermissible. Reasoning information includes all of the factors that can affect permissibility (described above), and can, in some embodiments, be accompanied by advice directed to selection of a permissible product component combination. Having this reasoning information available for consideration, customers can then return to the customization process and avoid encountering similar problems or repeating previous mistakes, such as specifying impermissible component combinations, when making decisions about future orders and specifications.

In an exemplary embodiment of the present invention, a prospective purchaser is presented with a series of product configuration choices including series of product component choices. A computer performing the method receives a series of product configuration choices from the prospective user, consults a database to determine whether the selected choices, in combination, are permissible, and displays (1) permissibility information, (2) reasoning information, and (3) advice to the prospective purchaser. These three pieces of information inform the user about whether the choices are permissible and, if not, about the nature of the impermissibility, including advice for making new selections that will lead to selection of permissible product component combinations.

The invention provides a number of advantages over prior art systems and methods for determining specifications and placing orders. For example, because product component options are not screened according to permissive combinations with product components already selected by a customer during the customization process, customers have access to a full range of product component options that is not limited by their previous product component selections. Also, advice generated and presented to the customer according to the present invention is able to guide customers as to which of several product component selections to change in order to convert an impermissible product component combination selection to a permissible one. Also, because reasoning information includes pricing data that can be easily updated and readily provided to customers while they are engaged in the configuration and ordering process, systems of the present invention eliminate the need to distribute cumbersome hard copy price sheets that quickly become outdated. The present invention also provides robust, user-friendly, easy to use software tools. Exemplary Web-based systems according to the present invention bring a plurality of tools together on the Web, such that they have a common look and feel to internal company users, sales people, and external customers. Exemplary systems, whether Web based, computer based, or otherwise, also provide platforms for easy integration with other Web or computer tools which may be pre-existing.

### BRIEF DESCRIPTION OF THE DRAWINGS

FIG. 1 illustrates an exemplary system that may be used in one embodiment of the present invention.

FIGS. 2-8 illustrate a sequence of screens that are generated by a wizard and used to interface between the computer and the user.

FIG. 9 illustrates a wizard user interface feedback screen for providing permissibility information, reasoning information and advice to a user.

### DETAILED DESCRIPTION OF EXEMPLARY EMBODIMENTS

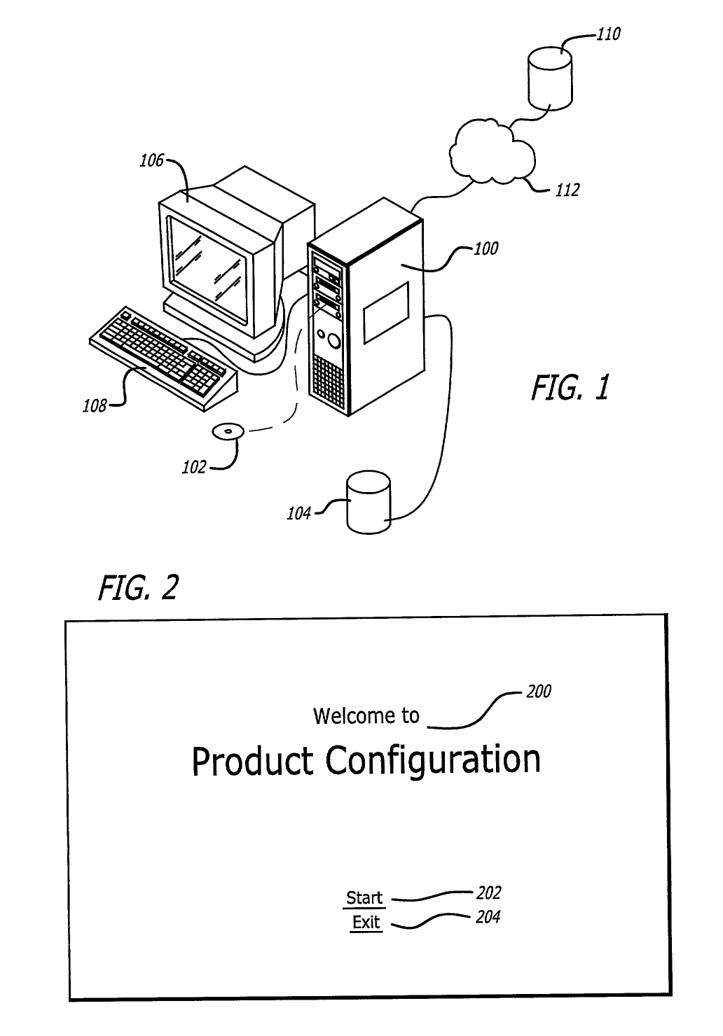

FIG. 1 illustrates an exemplary computer system that incorporates an embodiment of the present invention. It includes a computer 100 for use by a user; and software stored on a computer-readable storage medium 102, such as a CD-Rom or a floppy disk. The software may also or instead be stored on a hard drive within computer 100. Alternatively, the software may be stored on a local database 104, connected to computer 100 on a local area network (LAN) or similar communications network. Computer 100 runs the software, and the user interfaces with computer 100 through display monitor 106 and a keyboard 108. Specifically, the user will view information produced as part of the methods of the present invention on display monitor 106, and will provide inputs to computer 100 through keyboard 108. The software, in an alternative system, is stored and executed remotely from a remote database 110 accessible by the user over the Internet or other communications network 112. A remote database 110 may also store information to be transmitted to the user through network 112, as described below.

In an exemplary embodiment, remote database 110 is a relational database management system (RDBMS). In the exemplary embodiment, database 110 is utilized to house and manipulate data relevant to an array of products available for configuration and ordering on the system. As will be apparent to those skilled in the art, users of this exemplary embodiment may access the data stored within database 110 according to a variety of methods. Such methods include, but are not limited to, user interface software operational on the World Wide Web such as at a member Web site, user interface software locally stored and operational on computer 100, such as a downloadable software application, or direct user interaction with a computer housing database 110 such as by touch-tone telephone signals. Access to the data may also be made available through Web or computer based maintenance tools for accessing databases. Systems according to the present invention may also include administration of user accounts, account authorization, security features, and the like.

Although different user interfaces are also within the scope of the present invention, the exemplary embodiment described herein utilizes a wizard format. Generally speaking, “wizards” are well known to those skilled in the art as software tools that guide a user through a specific, multi-step process. In the exemplary embodiment, the wizard user interface guides a user through a series of questions or query options relevant to customizing and ordering a product having multiple product components. FIGS. 2-9 illustrate an exemplary wizard user interface. Specifically, these figures illustrate a presentation of a series of user queries that are generated and presented to the user by the wizard user interface, followed by product construction information, availability feedback, and other information useful to customers, as will be explained herein. Of course, it will be recognized by those skilled in the art that the series of illustrations representing user queries and feedback presented to a user through the wizard user interface are exemplary queries for an illustrative series of wizard user interface screens. It is anticipated as being within the scope of the present invention that different series of questions and sets of information will be presented to users through the wizard user interface.

Utilizing the wizard user interface, the user is able to customize and order a product with certain information related to his or her needs or preferred specifications. In particular, certain products may comprise a variety of component elements and be manufactured or produced after an order for such products is received. In such a situation, it is useful for a customer to have information regarding permissible combinations of such component elements. As described above, one example of permissibility information would be vendor availability and geographic location of various product components that are in stock with a vendor. Availability and location will affect pricing and time required for construction and delivery of the product. This exemplary permissibility information will help assure that the customer is steered toward selecting a viable combination of component elements and orders a product whose component combinations are permissible.

The present invention provides useful information to customers in the form of reasoning information and advice. The reasoning information is designed to contain detailed information regarding impermissibility of product component combinations. Details contained in the advice will allow the user to make informed revised decisions in the event a particular selected product component combination is impermissible and must be re-selected or re-ordered. The exemplary embodiment of the present invention prompts a user, through the user interface, to select certain product components. As the wizard user interface progresses through selections, permissibility information is generated and presented to the user. For example, if a user selects two component elements that are capable of being combined, the wizard user interface will progress to a new screen and proceed with ascertaining information from the user. If, on the other hand, a user selects a product component that cannot be combined with a previous selection, feedback is generated and provided to the user to indicate the impermissibility of the combination of selected product components. For example, the feedback may include a description of a physical incompatibility between two selected product components, allowing the user to decide which of the two components he will choose to modify in his next customization and order attempt. Therefore, the user is not constrained to choices of compatible product components; rather, the user is presented with choices of all product components, regardless of permissibility of combination, such that he has knowledge of the full range of available product components. The advice is presented to the user as an additional set of information, to assist in his decision making and selection process.

A specific example is illustrated in FIGS. 2-9, which illustrate an exemplary series of user queries and information feedback presented to a user through a wizard user interface. The exemplary embodiment is described herein as applied to a process of customizing and ordering labels. Therefore, product configuration options as described herein refer to product components that relate to the exemplary label configuration embodiment. However, it will be readily apparent to those skilled in the art that the methods of the present invention may be used in connection with a number of different products or services, and therefore will include a plurality of different product and service configuration options applicable to the specific product or service. Therefore, although the description herein continues with reference to the exemplary label configuration embodiment, the invention is not limited to that particular example.

FIG. 2 illustrates the entry point of an ordering process as conducted by the exemplary wizard user interface, wherein the user is visually welcomed to the beginning of the exemplary method, as shown at reference numeral 200. The welcome screen includes two links, such as hypertext embedded links, that direct the user to other screens within the wizard user interface. To activate the links, the user would select or “click” on them with an external input device, such as keyboard 108 or a mouse, respectively. Specifically, a start link 202, directs the user to the first step of the ordering process, and an exit link 204 directs the user out of the process and may also terminate the process.

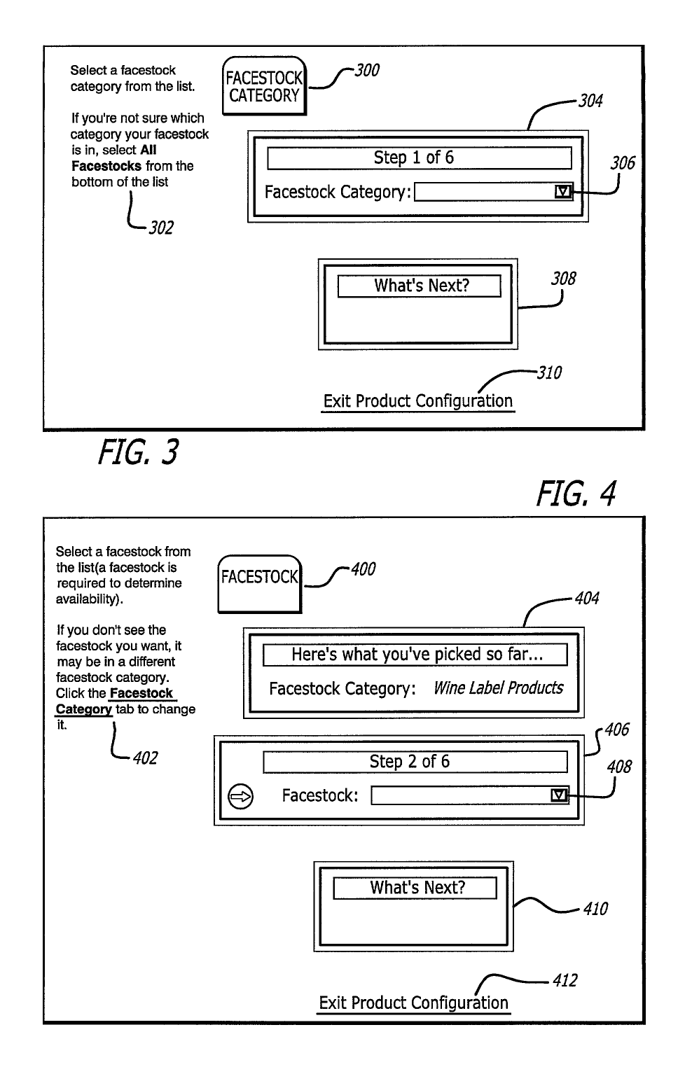

FIG. 3 illustrates the first step of the exemplary ordering process. At this point, the user has entered the process through the welcome screen, and is ready to select a first product component of the label he is attempting to configure and order. The purpose of the screen is indicated by an information tab 300, which clearly identifies to the user the purpose of the current step in the process. Also, instructions 302 for completing the process of this screen are provided to the user along an edge of the screen, so as to be informative yet unobtrusive. As indicated by information tab 300 and instructions 302, the user is prompted at prompt box 304 to select a facestock category. The selection may be made, for example, through a pull down menu 306 or other selection means. Pull down menu 306 presents the user with a plurality of choices for a first product configuration option. Specifically, in the exemplary label configuration embodiment, the first product configuration option involves type of facestock with which the label is to be constructed. Subsequently presented product configuration options, as described below, will involve other parts of the label. In addition to actions related specifically to this step of the process, such as reviewing facestock options and selecting one choice, the user is provided with additional information and options on this screen. For example, the user may preview a list of which steps will be next in the process, at preview pane 308. Also, a user can activate an exit link 310 to discontinue the customization and ordering process.

FIG. 4 illustrates the second step in a series of steps of the exemplary ordering process wherein a second product configuration option is presented to the user for selection. Specifically, in the exemplary label configuration embodiment, this screen of the wizard user interface prompts a user to select a facestock in the process of ordering a customized label, as also indicated by an information tab 400 and instructions 402. This second step screen shows the user which facestock category was selected in the previous step at history pane 404, and also prompts the user to select the actual facestock at prompt box 406. The selection may be made with drop down menu 408 or other selection means. Again, a preview pane 410 and exit link 412 are provided to the user on this screen.

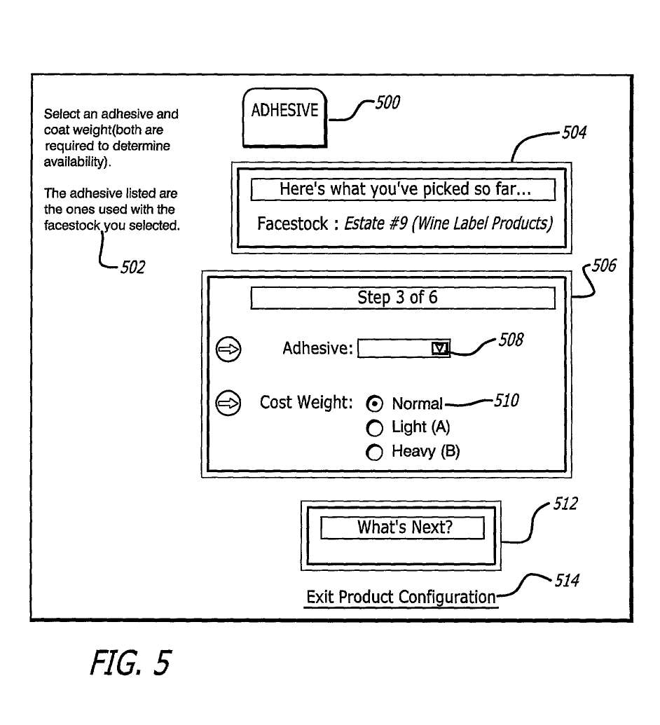

Next, FIG. 5 illustrates the third step in the series of steps of the ordering process wherein a third product configuration option within a series of product configuration options is presented to the user for selection. As indicated by information tab 500 and instructions 502, this screen prompts the user to make selections regarding the adhesive of the labels he is customizing and ordering. History pane 504 shows the user what product components have been selected so far, while prompt box 506 provides product component options to the user. The type of adhesive may be selected with drop down menu 508, and the amount of adhesive applied to the customized labels is selected with radio buttons 510, or other selection means. The user is informed as to the next steps in the process at preview pane 512, and may exit the process through exit link 514.

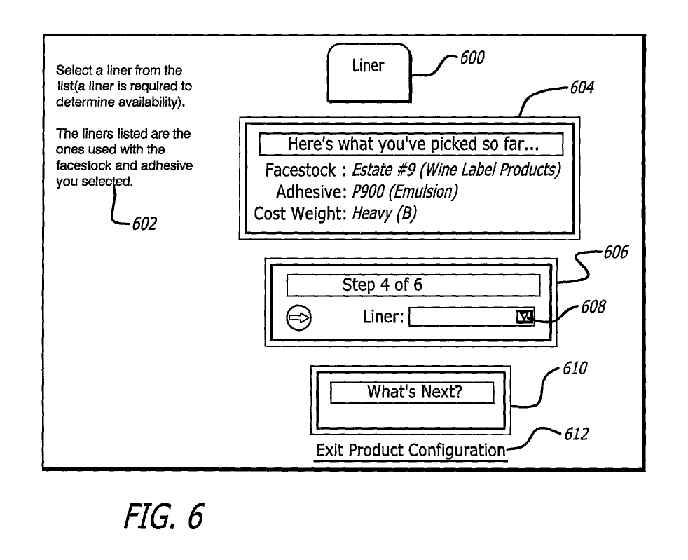

Continuing with the series of product configuration options, FIG. 6 illustrates the fourth step in the series of steps of the ordering process. As indicated by information tab 600 and instructions 602, this screen prompts the user to make selections regarding the liner of the labels he is customizing and ordering. History pane 604 shows the user what product components have been selected so far, while prompt box 606 provides product component options to the user. The type of liner is selected with drop down menu 608 or another selection means. Subsequent steps are listed for the user in preview pane 610, and the user may exit the process through exit link 612.

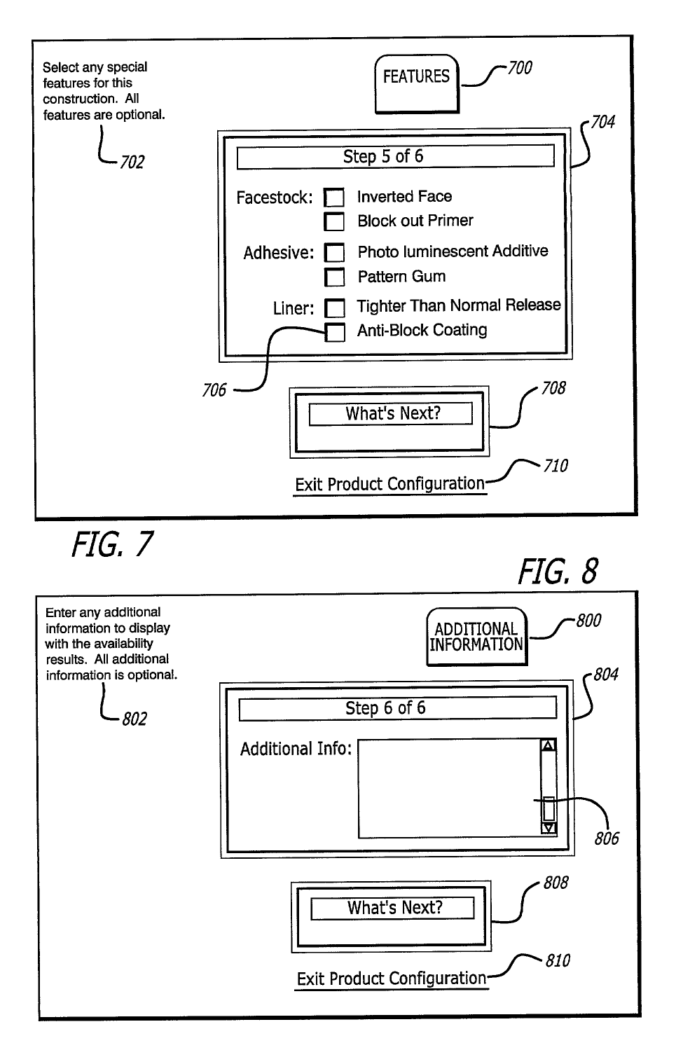

FIG. 7 illustrates the fifth step, in a series of product configuration option presentations, of the configuration and ordering process. As indicated by information tab 700 and instructions 702, this screen prompts the user to make selections regarding various other product components of the labels he is customizing and ordering. Prompt box 704 provides various product component options to the user, that are selected by the user with check boxes 706. Subsequent steps are listed for the user in preview pane 708, and the user may exit the process through exit link 710.

FIG. 8 illustrates the sixth step of the ordering process. As indicated by information tab 800 and instructions 802, this screen prompts the user to enter additional information about the labels he is customizing and ordering. Prompt box 804 indicates to the user to submit the additional information through text box 806. Subsequent steps of the process are listed for the user in preview pane 808, and the user may exit the process through exit link 810.

Additional, similar steps are repeated until enough information is collected from the user to determine whether he has specified a product having permissible product component combinations. Specifically, these determinations may be made by consulting a database that stores information regarding product component combination permissibility.

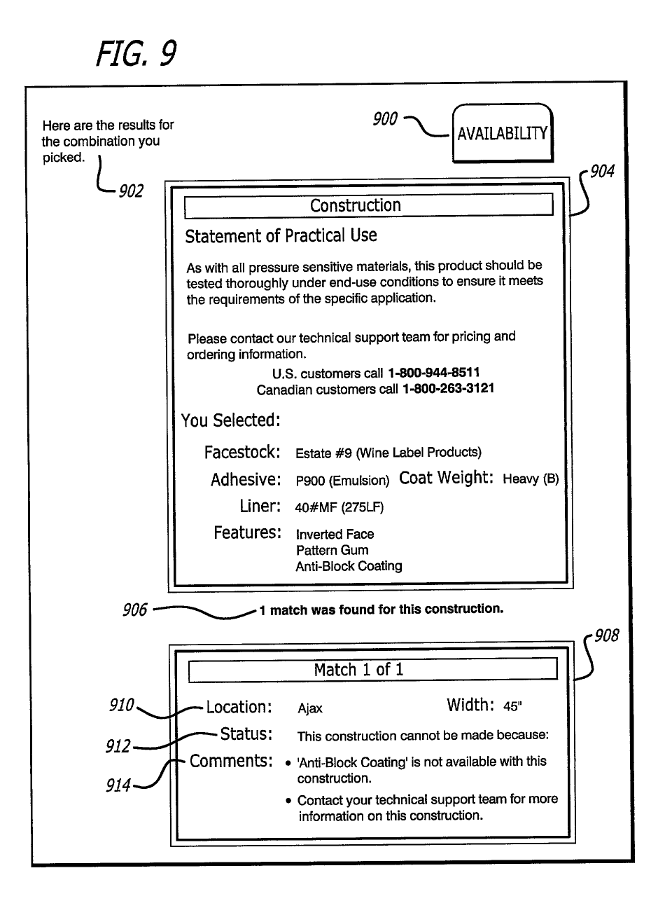

As illustrated in FIG. 9 the user is provided with permissibility information and advice, as indicated by information tab 900 and instructions 902. For example, a report box 904 displays for the user details about features of the labels he customized. A report statement 906 reports to the user whether the customized label having all of the features he specified in the previous steps of the process can be constructed. In the event that the label is unavailable or can not be constructed according to the user's specifications, information box 908 provides the user with specific permissibility information about the product ordered. Location information is provided as indicated at reference numeral 910, while status of the ordered product is indicated at reference numeral 912. Other permissibility information is reported to the user as comments, as indicated at reference numeral 914. These comments reasoning information, which indicates reasons about why the selected product components result in an impermissible combination. The reasoning information can then be used by the customer when re-formulating his specifications and order, such that an otherwise inefficient process now has a clear direction and becomes efficient and time-saving.

In the event that a selected product component combination is permissible, the permissibility information in information box 908 is accompanied by advice that includes information about other available options. In the case of ordering label constructions, advice may include, for example, available widths, colors, pricing information, and the like, for the label constructions specified by the user. It should be noted that various embodiments of the invention may utilize different types of permissibility information, reasoning information and advice. For example, different classes of users may be provided different types or amounts of permissibility information, reasoning information and advice.

The feedback information generated by the exemplary system assists the user in his or her decisions leading to an eventual order placement. Accordingly, the feedback information may be provided to the user at various times and by various methods. For example, a user may proceed through all screens of the wizard user interface, and the exemplary system will provide feedback at the completion of the query process. The feedback is therefore useful in formulating additional, or modified, user selections and orders.

A more efficient method of providing permissibility information, reasoning information and advice is also contemplated, wherein a user is informed of the permissibility or impermissibility immediately upon selection of a particular component element. Such information may take a number of different forms. For example, direct information may be provided to the user, indicating that a selected product component is not in stock or results in an otherwise impermissible combination with a previously selected product component. Alternatively, the wizard user interface may itself be adjusted according to the user's previous inputs. That is, when the user selects a particular component element, the information presented to the user in the next screen of the wizard user interface is customized according to the user's selection, although without screening out product component options that would result in impermissible combinations with previously selected product components. For example, additional advice information might be generated and presented to a user on a subsequent wizard user interface screen based upon the user's prior selection in a previous wizard user interface screen. The continuous updating of information presented in the wizard user interface maximizes the user's efficiency, as the user gains more knowledge about permissible product component combinations.

An exemplary line of products usable with systems of the present invention is now discussed for purposes of illustration. However, it should be realized that the invention may be practiced with an unlimited number and variety of products, services, and the like. In the exemplary embodiment, users are granted permissibility information, reasoning information and advice relative to ordering customized labels. Users will select the type of facestock, adhesive, liner, and other product components to be incorporated in the customized labels. Other information provided by the user will include customer ordering information, such as name, ordering number, and other identifying information as necessary. An availability page may also be incorporated into the wizard user interface, such that at the conclusion of a user's input, the user is provided with a variety of information relevant to the availability or possibility of constructing labels according to the user's specifications.

It should be recognized that the present invention provides more than simple positive or negative feedback regarding availability of a product. For example, the availability page described above includes additional information, such as comments or suggestions for modifying an unsuccessful order. This information provides efficiency to the user, and is a novel method for assisting a user with creating a customized product and placing an order therefor. Further, users may be provided with information regarding location of products matching their specifications, and can be allowed to view previously saved results. For example, permissibility information can be printed and saved, allowing users to retain copies of the information for future reference and utilization. Alternatively, permissibility information and customer selections can be saved digitally, such as on local computer storage media or in a remote member account, for future reference by users.

It is to be understood that other embodiments may be utilized to practice the present invention and structural and functional changes may be made thereto without departing from the scope of the present invention. The foregoing description of exemplary embodiments of the present invention have been presented for purposes of enablement, illustration, and description. They are not intended to be exhaustive of or to limit the present invention to the precise forms discussed. Many modifications and variations of the present invention are possible in light of the above teachings. For example, the invention may be practiced on a number of different computer systems and may utilize a variety of software application embodiments. Further, the invention is not limited to use with a single type of product. Rather, the invention may be used to facilitate the discovery and ordering of a wide range of customizable products spanning a large array of markets. Moreover, systems and methods of the present invention need not be limited to products offered for sale. Rather, embodiments of the invention may be used to determine impermissibility of user-selected product component combinations of any article for any purpose, where applicable. In short, the invention is limited only by the following claims.

We claim:

1. A method for configuring and ordering a product or service, comprising:
presenting a user with a series of product configuration options;
receiving a series of product configuration selections from the user in response to the presenting;
consulting a database to determine whether the selected product configuration options result in a permissible combination; and
informing the user whether the selected options result in a permissible combination and, if not, providing the user with information about the nature of the impermissibility.

2. The method of claim 1 wherein the product is a label.

3. The method of claim 2 wherein the series of product configuration options include types of facestock.

4. The method of claim 2 wherein the series of product configuration options include types of adhesive material.

5. The method of claim 2 wherein the series of product configuration options include types of facestock, types of adhesive material, and types of liner material.

6. The method of claim 1, further comprising:
after the informing the user about the nature of the impermissibility, presenting the user with the series of product configuration options; and
in response, receiving a new series of product configuration selections from the user.

7. A method for providing product configuration and ordering options comprising:
providing a user with a first choice of a first product component;
receiving, from the user, a first input representing a selection of the first product component;
providing the user with a second choice of a second product component;
receiving, from the user, a second input representing a selection of the second product component;
determining whether the selection of the first product component and the selection of the second product component result in a permissible combination;
providing permissibility information to the user, the permissibility information representing the determination of whether the selection of the first product component and the selection of the second product component result in a permissible combination; and
providing the user with reasoning information indicating a reason that the combination of the selected first product component and the selected second product component is or is not permissible.

8. The method of claim 7 wherein the determining whether the selection of the first product component and the selection of the second product component result in a permissible combination includes consulting a database.

9. The method of claim 7 wherein the permissibility information indicates that the combination of the first selected product component and the second selected product component is permissible; and
the method further comprising submitting an order for a product including the first product component and the second product component.

10. The method of claim 7 wherein the permissibility information indicates that the selection of the first product component and the selection of the second product component result in an impermissible combination, the method further comprising:
providing the user with the first choice of the first product component;
receiving, from the user, the first input representing the selection of the first product component;
providing the user with the second choice of the second product component;
receiving, from the user, a second input representing a selection of the second product component;
determining whether the selection of the first product component and the new selection of the second product component result in a permissible combination; and
if the combination of the selected first product component and the selected second product component is permissible, submitting an order for a product including the selected first product component and the selected second product component;
wherein either the first input is different from the subsequently received first input or the second input is different from the subsequently received second input.

11. The method of claim 10 wherein the reason comprises product availability information.

12. The method of claim 7 wherein the first product component comprises facestock type.

13. The method of claim 7 wherein the first product component comprises adhesive type.

14. Computer readable media containing programming code that, when loaded and executed on a computer, causes the computer to:
provide a user with a first choice of a first product component;
receive, from the user, a first input representing a selection of the first product component;
provide the user with a second choice of a second product component;
cause a computer to receive, from the user, a second input representing a selection of the second product component;
determine whether the selection of the first product component and the selection of the second product component result in a permissible combination; and
provide permissibility information to the user, the permissibility information representing the determination of whether the selection of the first product component and the selection of the second product component result in a permissible combination.

15. The computer readable media of claim 14 wherein the determining whether the selection of the first product component and the selection of the second product component result in a permissible combination includes causing the computer to consult a database.

16. The computer readable media of claim 14 wherein the permissibility information indicates that selection of the first product component and the selection of the second product component result in a permissible combination; and
when loaded and executed on a computer, further causes the computer to submit an order for a product including the first product component and the second product component.

17. The computer readable media of claim 14 wherein the permissibility information indicates that the selection of the first product component and the selection of the second product component result in an impermissible combination, and
the computer readable media, when loaded and executed on a computer, further causes the computer to:
provide the user with reasoning information indicating a reason that the selection of the first product component and the selection of the second product component result in an impermissible combination;
provide the user with the first choice of the first product component;
receive, from the user, the first input representing the selection of the first product component;
provide the user with the second choice of the second product component;
receive, from the user, a second input representing a selection of the second product component;
determine whether the selection of the first product component and the selection of the second product component result in a permissible combination; and
submit an order for a product including the selected first product component and the newly selected second product component if the selection of the first product component and the new selection of the second product component result in a permissible combination;
wherein either the first input is different from the previous first input or the second input is different from the previous second input.

18. The computer readable media of claim 17 wherein the reasoning information comprises product availability information.

19. A system for providing product configuration and ordering options, comprising:
a server computer operable for delivering to a user a series of product configuration options and for receiving, in response, a series of product configuration selections from the user;
a database containing permissibility information about the product configuration options; and
the server computer further operable for delivering advice to the user about whether the selected options result in a permissible combination and, if not, about the nature of the impermissibility.

20. The system of claim 19 wherein the delivering and the receiving are transacted across the Internet.

21. A system for providing product configuration and ordering options, comprising:
a computer operable for presenting to a user a series of product configuration options and for receiving, in response, a series of product configuration selections from the user;
a storage medium, operatively connected to the client computer, containing permissibility information about the product configuration options; and
the client computer further operable for presenting advice to the user about whether the selected options result in a permissible combination and, if not, about the nature of the impermissibility.
